(19) United States
(12) Patent Application Publication
(10) Pub. No.: US 2026/0162442 A1
(43) Pub. Date: Jun. 11, 2026

(54) METHOD AND SYSTEM FOR IDENTIFYING, FLAGGING, AND RECTIFYING UNEXPECTED TRAFFIC SIGN DATA

(71) Applicant: GM GLOBAL TECHNOLOGY OPERATIONS LLC, Detroit, MI (US)

(72) Inventors: Vivek Vijaya Kumar, Shelby Township, MI (US); Mason D. Gemar, Cedar Park, TX (US); Milan Kumar Biswal, Las Cruces, NM (US); Abdulrahman Al-Shanoon, Toronto (CA)

(73) Assignee: GM GLOBAL TECHNOLOGY OPERATIONS LLC, Detroit, MI (US)

(21) Appl. No.: 18/976,933

(22) Filed: Dec. 11, 2024

(51) Int. Cl. G06V 20/58; G06V 10/762; G06V 10/764; G06V 10/776; G06V 20/30

(52) U.S. Cl. CPC G06V 20/582; G06V 10/762; G06V 10/764; G06V 10/776; G06V 20/30

(57) ABSTRACT

A system and method for identifying, flagging, and rectifying unexpected traffic sign data including capturing traffic sign data utilizing a multitude of vehicles, where each vehicle includes a front sensor to capture the traffic sign data and then collect and store the captured traffic sign data from the multitude of vehicles over a span of time. One or more potential false traffic sign detections are identified from the captured traffic sign data including identifying and flagging, based on a road category and an associated rule. An average vehicle speed during a non-maximal traffic period for one or more traffic zones is determined and then filtered based on a traffic sign category to determine, based on the determination of an average vehicle speed during a non-maximal traffic period, a most likely traffic sign legend.

### INTRODUCTION

Vehicles are rapidly integrating ever increasing technological components into their systems. Special use microcontrollers, technologies, and sensors may be used in many different applications in a vehicle. Automotive microcontrollers and sensors may be utilized in enhancing automated structures that offer state-of-the-art experience and services to the customers, for example in tasks such as body control, camera vision, information display, security, autonomous controls, etc. Further, functions such as adaptive cruise control, lane change assist, and vehicle proximity detection may use a variety of sensors using camera, light detection and ranging (LIDAR), radio detection and ranging (RADAR), ultrasonic, and other technologies to accomplish their functions.

However, with the prolific use of such automated controls, there is an ever-increasing possibility of false detections, for example in the optical recognition of traffic signs. Thus, where optical recognition may affect vehicle controls, for example, adaptive cruise control, the ability to mitigate and correct false detections is critical.

### SUMMARY

Disclosed herein is a system and method for identifying, flagging, and rectifying unexpected traffic sign data. As disclosed herein, a multitude of vehicles, for example using a crowdsourcing algorithm, may be used to capture and analyze traffic sign data. Such data may be captured during different parts of the day, for example when the traffic is congested, and also during minimal congestion where vehicles may travel at higher speeds. However, due to environmental conditions, or optical aberrations, a camera in a vehicle may misinterpret a traffic sign, for example by identifying a traffic speed sign as displaying “25” instead of its actual value of “45.”

Thus, a system for identifying, flagging, and rectifying unexpected traffic sign data may include multiple vehicles, each vehicle being equipped with a front sensor, for example a camera module, to capture traffic sign data. The system may include a system, such as a traffic sign data aggregation system that may collect and store the captured traffic sign data from the vehicles over a span of time. The traffic sign data aggregation system may then be used to identify and flag one or more potential false traffic sign detections, from the captured traffic sign data, based on a road category and an associated rule, for example, a speed limit rule, a yield sign rule, or a stop sign rule. A time and spatial filtering system may then be used to determine, for one or more traffic zones, an average vehicle speed during a non-maximal traffic period, and then filter the captured traffic sign data based on a traffic sign category, for example, a speed limit category, a stop sign category, or a yield sign category. The traffic sign data aggregation system may then determine from the filtered captured traffic sign data, based on the time and spatial filtering system determinations, a most likely traffic sign legend, for example, a speed limit value, a stop sign, or a yield sign.

Another aspect of the disclosure may include the system where the traffic sign data aggregation system is further configured to perform a data curation to filter un-fit data including data from a selected vehicle identified as a source of error in determining a traffic sign speed limit value.

Another aspect of the disclosure may include the system where the traffic sign category includes, but is not limited to, a speed limit sign, a stop sign, or a yield sign.

Another aspect of the disclosure may include the system where the road category includes a primary, a secondary, and a tertiary.

Another aspect of the disclosure may include the system where the traffic sign data aggregation system is further configured to flag one or more false traffic sign detections as a high risk when the road category is not a primary level, and the speed limit is greater than a threshold value.

Another aspect of the disclosure may include where the system further performs data clustering by grouping traffic sign data associated with a single particular traffic sign.

Another aspect of the disclosure may include the system where the captured traffic sign data from the plurality of vehicles over a span of time comprises data collected and analyzed by a crowdsourcing algorithm.

Another aspect of the disclosure may include the system where the time and spatial filtering system applies a distribution method to process crowdsourced telemetry data including an estimated confidence score.

Another aspect of the disclosure may include the system where the distribution method further comprises estimating a confidence score based on determining a maximum peak value and a qualified peak value from the crowdsourced telemetry data.

Another aspect of the disclosure may include the system where the time and spatial filtering system performs a de-duplication process based on the determined most likely traffic sign legend.

Another aspect of the disclosure may include the system where the time and spatial filtering system is further configured to filter data based on a speed limit category by filtering out speed values less than a threshold value.

Another aspect of the disclosure may include a method for identifying, flagging, and rectifying unexpected traffic sign data including capturing traffic sign data utilizing a plurality of vehicles, where each vehicle includes a front sensor to capture the traffic sign data. The method may continue by collecting and storing the captured traffic sign data from the plurality of vehicles over a span of time and identifying and flagging one or more potential false traffic sign detections, from the captured traffic sign data, based on a road category and an associated rule. The method may include determining, for one or more traffic zones, an average vehicle speed during a non-maximal traffic period and filtering the captured traffic sign data based on a traffic sign category and determining from the filtered captured traffic sign data, based on the determining of an average vehicle speed during a non-maximal traffic period, a most likely traffic sign legend.

Another aspect of the disclosure may include where the method performs a data curation to filter un-fit traffic sign data including data from a selected vehicle identified as a source of error in determining a traffic sign speed limit value.

Another aspect of the disclosure may include where the traffic sign category includes a speed limit sign, a stop sign, or a yield sign.

Another aspect of the disclosure may include where the method flags one or more false traffic sign detections as a high risk when the road category is not a primary level, and the speed limit is greater than a threshold value.

Another aspect of the disclosure may include where the method performs data clustering by grouping traffic sign data associated with a single particular traffic sign.

Another aspect of the disclosure may include where the captured traffic sign data from the plurality of vehicles over a span of time comprises data collected and analyzed by a crowdsourcing algorithm.

Another aspect of the disclosure may include where the method applies a distribution method to process crowdsourced telemetry data including estimating a confidence score based on determining a maximum peak value and a set of qualified peak values.

Another aspect of the disclosure may include where the method performs a de-duplication process based on the determined most likely traffic sign legend.

Another aspect of the disclosure may include a method for identifying, flagging, and rectifying unexpected traffic sign data including capturing traffic sign data utilizing a plurality of vehicles, where each vehicle includes a front sensor configured to capture the traffic sign data. The method may also include collecting the captured traffic sign data from the plurality of vehicles over a span of time and identifying and flagging one or more potential false traffic sign detections, from the captured traffic sign data, based on a road category and an associated rule. The method may continue with determining, for one or more traffic zones, an average vehicle speed during a non-maximal traffic period and filtering the captured traffic sign data based on a traffic sign category, where the traffic sign category includes a speed limit sign, a stop sign, or a yield sign. The method may continue with determining from the filtered captured traffic sign data, based on the determining of an average vehicle speed during a non-maximal traffic period, a most likely traffic sign legend while also performing a data curation to filter un-fit traffic sign data including data from a selected vehicle identified as a source of error in determining a traffic sign speed limit legend and flagging one or more false traffic sign detections as a high risk when the road category is not a primary level and the speed limit is greater than a threshold value. The method may also include performing data clustering by grouping traffic sign data associated with a single particular traffic sign and applying a distribution method to process crowdsourced telemetry data including estimating a confidence score based on determining a maximum peak value and a set of qualified peak values and performing a de-duplication process based on the determined most likely traffic sign legend, where the road category includes a primary, a secondary, and a tertiary, and where the captured traffic sign data from the plurality of vehicles over a span of time comprises data collected and analyzed by a crowdsourcing algorithm.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of a false traffic sign detection on a secondary road, in accordance with the disclosure.

FIG. 2 is a flow chart for identifying, flagging, and rectifying unexpected traffic sign data, in accordance with the disclosure.

FIG. 3 is an illustration of flag condition of classifying risk associated with unexpected traffic sign data, in accordance with the disclosure.

FIG. 4 is an illustration of in-vehicle detection of potential false traffic sign detection, in accordance with the disclosure.

FIG. 5 is an illustration of the use of confidence scoring of crowdsourced traffic sign data processing, in accordance with the disclosure.

FIG. 6 is an illustration of processing crowdsourced traffic sign data, in accordance with the disclosure.

FIG. 7 is an illustration of estimating a confidence score for a detected speed limit based on crowdsourced vehicle speed data distribution, in accordance with the disclosure.

FIG. 8 is an illustration of a distribution of crowdsourced vehicle speed data used in the de-duplication process of crowdsourced traffic sign data, in accordance with the disclosure.

FIGS. 9A, 9B, and 9C illustrate three examples of high speed vehicle telemetry raw data utilization in a de-duplication process, in accordance with the disclosure.

FIG. 10 depicts a flowchart of a method for identifying, flagging, and rectifying unexpected traffic sign data, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

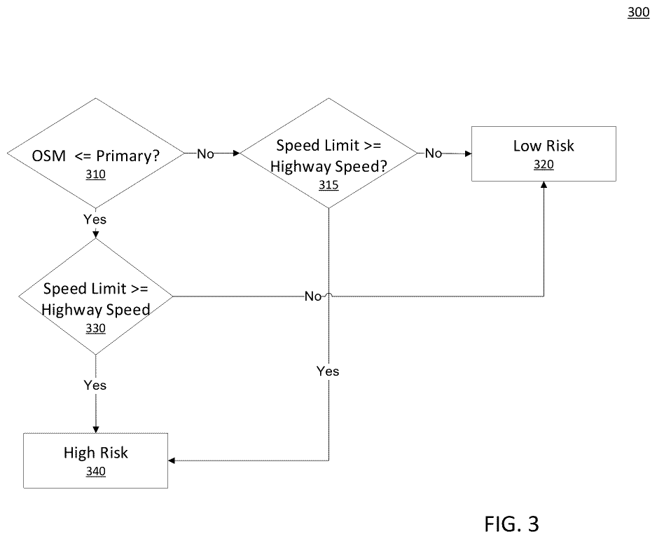

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Autonomous vehicle and advanced driver assistance systems (AV/ADAS) such as adaptive cruise control, traffic sign recognition, automated parking, automatic brake hold, automatic braking, evasive steering assist, lane keeping assist, adaptive headlights, backup assist, blind spot detection, cross traffic alert, local hazard alert, and rear automatic braking may depend on information obtained from cameras and sensors on a vehicle. As these types of features become more prevalent in vehicles the sensors that are relied on to enable such features are susceptible to misinterpretation, for example the weather that may obscure camera sensors and produce false detections. Crowdsourcing may also be utilized to improve confidence in detection, for example traffic signs. Rather than relying on just a vehicle's sensors, those sensors may be used in combination with data from a multitude of vehicles.

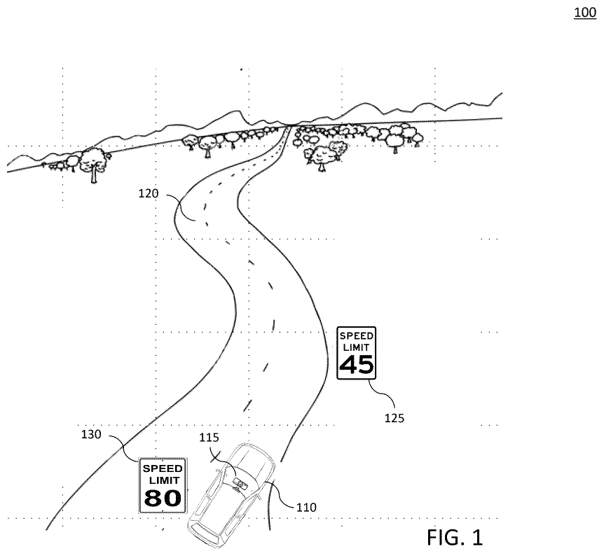

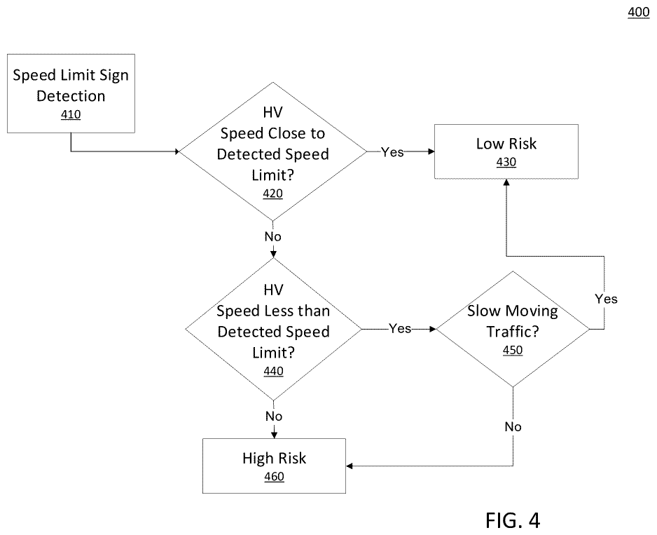

FIG. 1 is an illustration of a false traffic sign detection scenario 100 on a secondary road, according to an embodiment of the present disclosure. In FIG. 1, host vehicle 110 is shown driving on a secondary road 120 and may be equipped with a sensor 115, for example a front camera module, which may be used for traffic sign recognition. Traffic sign recognition may include the recognition of speed limit signs, such as traffic sign 125, but may also be other category types of signs such as a stop sign, a yield sign, a crossing sign, one-way traffic signs, route or interstate highways number signs, turn signs, etc. Scenario 100, however, illustrates that host vehicle 110 has processed a captured image of traffic sign 125 but mistakenly detects that the posted speed is 80 miles per hour as indicated by detected speed limit 130, rather than the actual posted speed of 45 miles per hour. As will be discussed in FIG. 3 and FIG. 4, such a false detection may represent a high or low risk. For example, a speed limit of 80 miles per hour on a curvy secondary road may not be the ideal scenario as the road may not be designed and constructed for such a high operating speed. In a similar scenario, if a vehicle falsely detects a 20 mile per hour speed limit on a highway with an actual speed limit of 70 miles per hour, reducing the vehicle speed to such an extent may present undesirable situations.

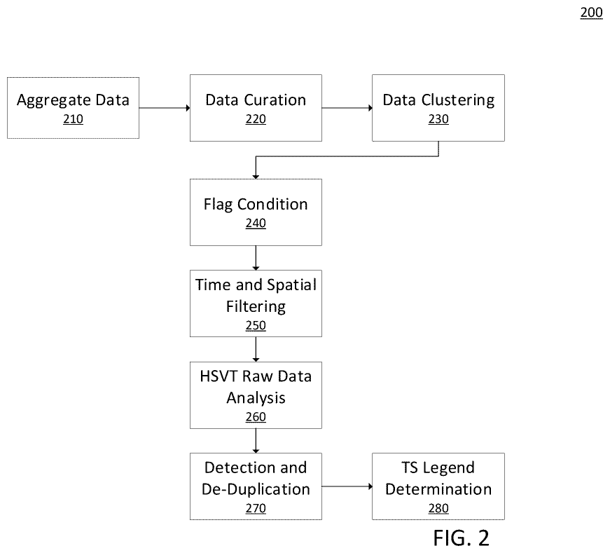

FIG. 2 is a flow chart 200 for identifying, flagging, and rectifying unexpected traffic sign data, according to an embodiment of the present disclosure. At step 210, aggregate data, traffic sign data may be collected from multiple vehicles over a span of time. For example, days or weeks of data may be collected, aggregated, and stored in the cloud or by a third-party provider. Crowdsourcing algorithms may be used to collect and analyze such traffic sign data.

At step 220, data curation, data may be filtered such that data that is un-fit for further processing may be deleted and/or ignored. For example, if the traffic on a highway with a speed limit of 60 miles per hour comes to a complete stop, for example with some type of obstruction, data indicating vehicles traveling at 0 miles per hour is not reflective of the actual posted speed limit and thus is un-fit for further processing.

At step 230, data clustering, traffic sign data for a particular traffic sign may be grouped. For example, if through the crowdsourcing process, vehicles report that there is a stop sign at the corner of “Main Steet” and “Center Street” but the various vehicles report the actual location of the sign existing at multiple positions along the same side of the road, for example +/−10 feet apart, that does not necessarily mean that there are multiple stop signs at that intersection.

At step 240, flag condition, may be used to identify and flag unexpected traffic signs and objects, for example, the 80 mile per hour speed limit false detection along a secondary road as discussed in FIG. 1. The flag condition will be discussed in further detail in FIG. 3 and FIG. 4.

At step 250, time and spatial filtering, free-flowing traffic may be detected from collected vehicle telemetry data. Free-flowing traffic may be considered as unhampered traffic flow, for example, without traffic congestion. Such free-flow traffic data may give a fairly accurate indication of the actual speed limit for a particular portion or zone of a roadway.

At step 260, high speed vehicle telemetry (HSVT) raw data from vehicles may be analyzed to determine false detections. HSVT is a byproduct of a system that allows for real-time data exchange between a vehicle and a central system.

At step 270, detection and de-duplication, based on the HSVT raw data analysis, an inferred traffic sign legend, for example a speed limit value, a stop sign, or a yield sign, may be determined. In addition, at step 270 a de-duplication process may be invoked to eliminate duplicate data for a particular traffic sign, for example the “multiple” traffic signs at an intersection discussed above.

At step 280, traffic sign legend determination, a most likely traffic sign value or legend may be determined from the de-duplicated data cross-checked against HSVT and saved/stored into a final traffic sign database.

FIG. 3 is an illustration of a flag condition process 300, according to an embodiment of the present disclosure. Process 300 may receive as input a clustered table of data from an external source that, for example, using road category and speed limit data may classify a flag condition of a potential false detection as being either a high risk or a low risk. Thus, at step 310, a determination may be made using an Open Street Map or other means of roadway classification on whether the road is a primary road type, for example a highway, divided highway, or interstate highway that may be designed for highway speed traffic. In contrast a road may be classified as a secondary or tertiary roadway. While primary roads may usually be limited-access highways with interchanges and ramps, secondary roads may include main arteries that may or may not be divided and may also include intersections. Thus, at step 310 if the road is determined to be a primary road and the detected speed limit is greater than, within a certain threshold, or equal to a typical primary road speed limit at step 315, then the flag condition may be set as a low risk at step 320. Then, in a situation where the speed limit may be less than a typical primary road speed, within a certain threshold, then the flag condition may be set to a high risk at step 340. However, if the road is determined to be less than a primary road category then at step 330 a determination may be made as to whether the speed limit is greater than a highway speed, for example 65 miles per hour. If the speed limit is less than a highway speed limit, then a determination may be made that the situation may again be classified as low risk at step 320. However, if the speed limit is categorized to be a greater than or equal to a highway speed and the roadway has been recognized as being less than a primary level, then the detection may be determined to be a high risk at step 340.

FIG. 4 illustrates a process 400 for in-vehicle detection of potential false detections, according to an embodiment of the present disclosure. Process 400 may not rely on external or crowdsourced traffic sign data, but rather may utilize internal sensors, for example a front camera module. Thus, at step 410 a sign may be detected utilizing the front camera module or other types of image capture devices including but not limited to light detection and ranging (Lidar), radar, or the like. While this example illustrates a speed limit traffic sign, the type of traffic sign is not limited to speed but may be of other types of traffic signs. At step 420 a determination may be made as to whether the host vehicle's speed is within a threshold amount of the detected speed captured by the front facing sensor. If the host vehicle speed is close and within the threshold amount of the detected speed limit, then the situation may be classified as a low risk at step 430. However, if the host vehicle speed is not close to the detected speed limit, then at step 440 a determination may be made as to whether the host vehicle speed is less than the detected speed limit. If it is less then a determination may be made at step 450 as to whether the host vehicle is part of a road congestion with slow moving traffic and if so, then the associated risk flag may be determined to be a low risk at step 430. However, if the host vehicle speed is less than the detected speed limit at step 440 and there is no slow-moving traffic detected at step 450, then the situation may be determined to be a high risk at step 460. And similarly, if the host vehicle speed is higher than the detected speed limit then the situation may also be flagged as a high risk at step 460.

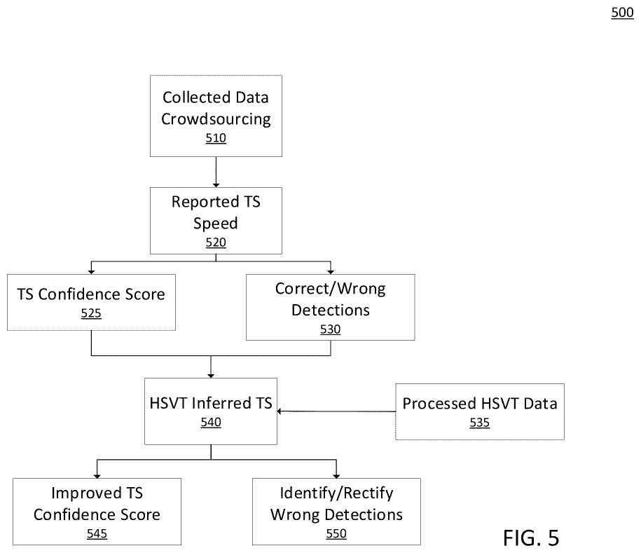

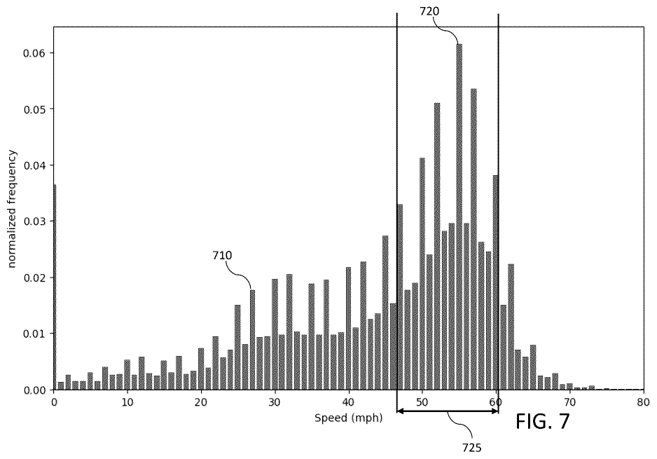

FIG. 5 illustrates the processing of high-speed vehicle telemetry 500 utilizing crowdsourced data, according to an embodiment of the present disclosure. At step 510, crowdsourced traffic sign data may be collected. Such data may include multiple types of traffic signs and may also include the traffic sign's associated location. Crowdsourced traffic sign data may be collected over time and pertain to one or more roadways. At step 520, based on the collected crowdsourced data in step 510, a determination may be made as to the reported traffic sign in question. In step 525 there may also be an associated confidence score associated with the reported traffic sign. There may also be, at step 530, a mixture of correct detection and one or more wrong detections associated with the reported traffic sign. The output of both step 525 and step 530 may be presented, in step 540, as the inferred traffic sign based on the processed high speed vehicle telemetry from step 535. The processed high speed vehicle telemetry may consist of multiple filters and distribution methods of raw high speed vehicle telemetry data. Such filtering may include time and spatial filtering to select free-flow traffic data where the average vehicle speed may be measured during low traffic volume periods and/or also be filtering out high congestion regions. In addition, a traffic sign filter may eliminate certain data by category type such as deleting low values of speed limits, keeping values associated with a stop sign, and also keeping values associated with a yield sign. Processing the high speed vehicle telemetry raw data may also include the use of distribution methods such as a histogram, density plot, and kernel density estimation to find the values range where most of the data exists, obtaining the minimum and maximum values of the highest bin, and determining an average of the highest bin. Examples of distribution methods will be further discussed in FIG. 7.

Thus, at step 540 the result of the high-speed vehicle telemetry may result in an improved traffic sign confidence score in step 545 and an ability to identify and/or rectify wrong traffic sign detections in step 550.

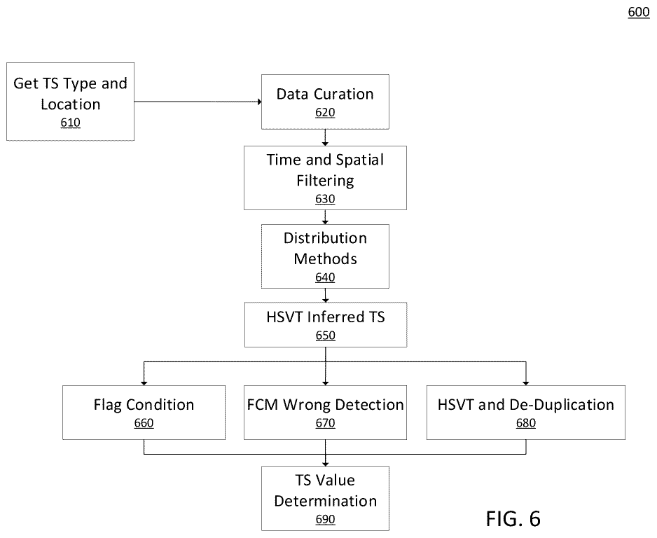

FIG. 6 is a further discussion of processing 600 of crowdsourced traffic sign data, according to an embodiment of the present disclosure. The processing 600 of high speed vehicle telemetry may begin at step 610 with obtaining traffic sign type and location data. Further, the traffic sign type and location data may then be grouped by the type of traffic sign, for example, by speed, stop, yield, etc. In addition, the data may also be grouped by an edge identification or road identification or designation. At step 620 the data may then be curated by filtering out low data based on a type of traffic sign, for example, the removal of zero speed data from a speed limit type of traffic sign.

At step 630 a time and spatial filtering may be used to select free-flow traffic data. For example, an average vehicle speed may be measured during low-volume periods of time, thus filtering our high congestion periods. Further, the high congestion periods may be defined by times when the traffic in one or more directions and segments or portions of a roadway is typically operating below free-flow speed, for example between 06:00-10:00 and between 15:00 and 18:00. These times are simply arbitrary and are not meant to be restrictive.

Next, a spatial filtering may be used to select a most appropriate set of telemetry data sample for analysis. For example, when processing highway telemetry data, samples near an exit/merge ramp may be filtered out. Similarly, for a city/residential road, samples near an intersection may be filtered out. This may be performed by using OSM (or other) road topology information such as vertices to identify where roads intersect and filter out samples using a distance threshold. Another method may include the ability to select vehicle telemetry samples within a distance threshold from the detected traffic sign. In addition, behavior near a posted traffic sign may be observed to further quantify the effect of the traffic sign and further confirm a legend of the associated traffic sign.

At step 640 distribution methods may be applied to the data and may include the use of histograms, density plots, kernel density estimation and the like. Such methods may include finding value ranges that contain the majority of data, for example the mode of a histogram. Then, a determination of the minimum and maximum values of the highest bin may be made, an average of the highest bin obtained, and a confidence score estimated.

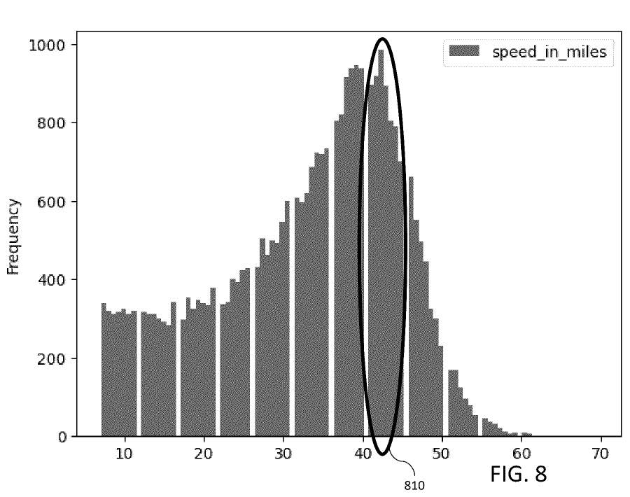

In step 650, based on the results of the distribution methods in step 640, a high-speed vehicle telemetry inferred traffic sign legend, for example, speed, stop, or yield, may be determined. The inferred traffic sign data of step 650 may then be further processed in step 660, step 670, and step 680. Step 660 flag condition may identify and flag unexpected traffic signs and objects. Step 670 may also determine false detections using vehicle sensors and further aggregate the incorrect detections. Step 680 may also perform a de-duplication process based on the inferred traffic sign data, which will be further discussed in FIG. 8.

Then, at step 690, based on the determinations of step 660, step 670, and step 680, a final traffic sign value or legend may be identified as the most likely traffic sign legend.

FIG. 7 is an estimation 700 of a confidence score of high-speed vehicle telemetry data based on data distribution, according to an embodiment of the present disclosure. FIG. 7 illustrates a spread of detected vehicle speeds on a particular segment of a roadway. Specifically, FIG. 7 illustrates a high-speed vehicle telemetry distribution or histogram for a particular segment of roadway showing detected speeds from 0 miles per hour up to 80 miles per hour. The histogram may also be normalized and then detect N number of peaks in the high speed vehicle telemetry bin distribution with a prominence of at least greater than a threshold amount, for example 25%, of the maximum peak value, as shown by example maximum peak value 720 and non-maximum peaks, for example peak 710. Next, the supporting bins around each peak, namely the consecutive points from the peak value shown by the supporting peaks span 725, with prominence greater than a threshold value, for example 50% of the peak value. From this an estimated confidence score may be determined as follows:

$${C}_{hsvt} = {\sum }_{∀ k ∈ support of maximum peak} {f}_{k} - {\sum }_{∀ j ∈ support of other qualified peak} {f}_{j}$$

Where fᵢ represents number of observations in the i^{th} bin with a scaling factor of β=0.5

FIG. 8 is an illustration of a HSVT-based filtering process based on high-speed vehicle telemetry raw data, according to an embodiment of the present disclosure. FIG. 8 illustrates an embodiment with a front mounted sensor, for example a camera, that may detect and interpret a traffic sign incorrectly, a false detection, for example as shown in FIG. 1. The next step is to create a flag condition to identify the false, or incorrect, detection, as discussed in FIG. 5. Then, the high-speed vehicle telemetry may be used to rectify the wrong detection if the traffic speed distribution at that location is inconsistent with the detected sign type or speed limit value. Thus, FIG. 8 illustrates a histogram of frequency versus speed in miles per hour where the maximum peak, shown in area 810, may be used to filter out the wrong detection.

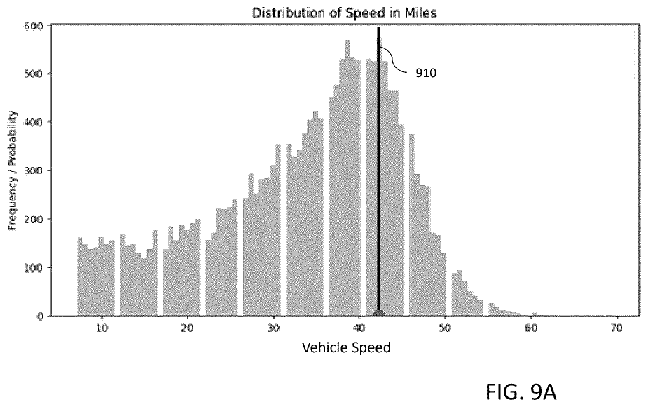

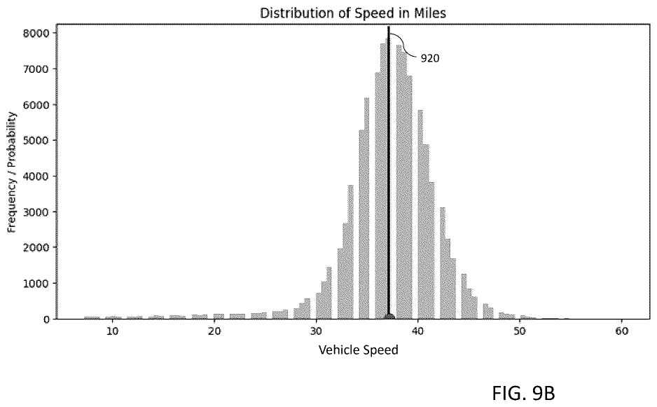

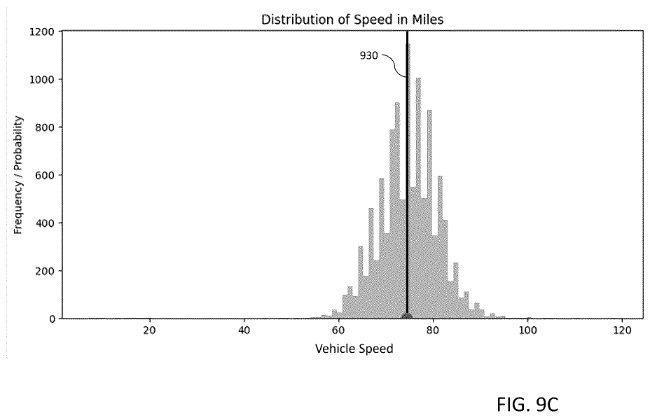

The following will discuss three example uses of high-speed vehicle telemetry raw data utilization in the de-duplication process as illustrated in FIGS. 9A, 9B, and 9C.

As shown in FIG. 9A, the first example may consist of using the front mounted sensor vehicle report that has falsely detected a traffic sign legend. The condition may then be flagged, using processes outlined earlier, and based on free-flow traffic data the distribution method may be applied on high-speed vehicle telemetry raw data speed observation to determine an inferred traffic sign legend. In FIG. 9A, for example this may be shown as an inferred speed limit of approximately 42 miles per hour, as indicated by the highest bin marker 910, with a confidence score greater than 0.5. The de-duplication may then be applied and a final value of the inferred traffic sign may be produced.

As shown in FIG. 9B, the second example may consist of using the front mounted sensor vehicle report that has falsely detected a traffic sign legend, for example an incorrect detection of 85 miles per hour speed limit in an actual 35 miles per hour speed limit zone. This example illustrates an incorrect recognition of a “3” for an “8.”. The condition may then be flagged, for example as discussed in FIG. 3, and based on free-flow traffic data the distribution method may be applied on high-speed vehicle telemetry raw data speed observation to determine an inferred traffic sign legend. In the FIG. 9B example this may be shown as an inferred speed limit of approximately 37 miles per hour, as indicated by the highest bin marker 920, with a confidence score of greater than 0.5, thus improving the confidence score of a “Speed Limit 35” and reducing the confidence of a “Speed Limit 85.” The de-duplication may then be applied, and a final value of the inferred traffic sign may be produced based on the higher-confidence outcome.

As shown in FIG. 9C, the third example may consist of using the front mounted sensor vehicle report that has falsely detected a traffic sign legend, for example an incorrect detection of a traffic sign indicating multiple speed limits. For example, the traffic sign may indicate a speed limit of 70 miles per hour, but also a speed limit of 65 miles per hour for trucks, and a minimum speed limit of 55 miles per hour. The condition may then be flagged by indicating the highest detected speed with respect to state rules and based on free-flow traffic data, the distribution method may be applied on high-speed vehicle telemetry raw data speed observations to determine an inferred traffic sign legend. In the FIG. 9C example this may be shown as an inferred speed limit of approximately 74.5 miles per hour, as indicated by the highest bin marker 930, with a confidence score of greater than 0.5, thus improving the confidence score of a “Speed Limit.” The de-duplication may then be applied, and a final value of the inferred traffic sign may be produced. In this case the higher speed limit value would be confirmed by observed traffic speeds.

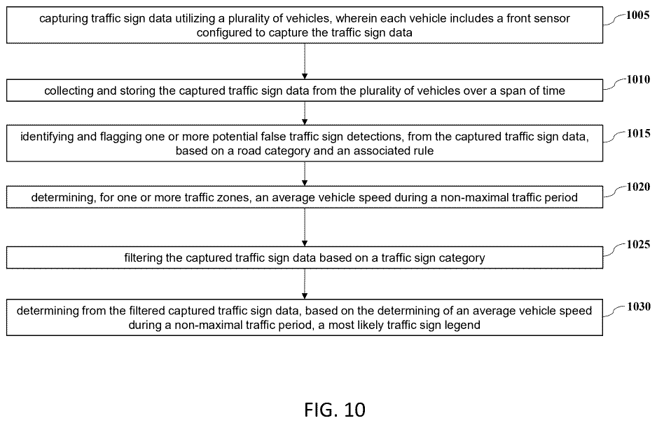

FIG. 10 shows an exemplary embodiment of a method for identifying, flagging, and rectifying unexpected traffic sign data, according to an embodiment of the present enclosure. Method 1000 begins at step 1005 with capturing traffic sign data utilizing a plurality of vehicles, wherein each vehicle includes a front sensor configured to capture the traffic sign data. As discussed in FIG. 4, a traffic sign may be detected utilizing the front camera module in the vehicle or other types of image capture devices including but not limited to light detection and ranging (Lidar), radar, or the like. While this example illustrates a speed limit traffic sign, the type of traffic sign is not limited to speed but may be of other types of traffic signs.

At step 1010 the method may continue with collecting and storing the captured traffic sign data from the plurality of vehicles over a span of time. The plurality of vehicles may also operate as a crowdsourcing entity where a crowdsourcing algorithm may be used to capture traffic sign data and where such data may be captured during different parts of the day, for example when the traffic is congested, and also during minimal congestion where vehicles may travel at higher speeds. Further, the method may utilize a system, such as a traffic sign data aggregation system that may collect and store the captured traffic sign data from the vehicles over a span of time.

At step 1015 the method may continue with identifying and flagging one or more potential false traffic sign detections, from the captured traffic sign data, based on a road category and an associated rule. A rule may include an associated action associated with a particular type of traffic sign. For example, a speed limit sign may be associated with a rule limiting a vehicle's speed limit for a particular roadway. A yield sign may be associated with a yield rule that controls which vehicle has a right of way. And, a stop sign may be associated with a rule of stopping, for example at an intersection. As discussed in FIG. 3, Process 300 may receive as input a clustered table of data from an external source that, for example, using road category and speed limit data may classify a flag condition of potential false detections as being either a high risk or a low risk. As also discussed in FIG. 3, a roadway may be categorized as a primary, secondary, or tertiary type road. While primary roads may usually be limited-access highways with interchanges and ramps, secondary roads may include main arteries that may or may not be divided and may also include intersections. Tertiary roads may include roadways outside urban areas with low to moderate traffic that links smaller villages or hamlets. Thus, as discussed in FIG. 3 at step 310, a determination may be made using an Open Street Map or other means of roadway classification on whether the road is a primary road type, for example a highway, divided highway, or interstate highway that may be designed for highway speed traffic. Further, as discussed in FIG. 3, if the road is determined to be a primary road at step 310 and where the speed limit is greater than highway speed at step 315, then the flag condition may be set as a low risk at step 320. However, if the road is determined to be less than a primary road category then at step 330 a determination may be made as to whether the speed limit is greater than a highway speed, for example 65 miles per hour. If the speed limit is less than a highway speed limit, then a determination may be made that the situation may again be classified as low risk at step 320. However, if the speed limit is categorized to be a greater than or equal to a highway speed and the roadway has been recognized as being less than a primary level, then the detection may be determined to be a high risk at step 340.

At step 1020 the method may include determining, for one or more traffic zones, an average vehicle speed during a non-maximal traffic period. A traffic zone may be a reference to a particular portion of a road. For example, a portion of a road that typically handles non-congested traffic, a free-flow traffic zone that may be associated with a precise geospatial searching method. Further, the reference of non-maximal is meant to describe a non-congested or free-flow traffic condition for a particular road that may be associated with one or more particular time periods of the day, week, month, or other period of time.

The method may continue at step 1025 with filtering the captured traffic sign data based on a traffic sign category. The traffic sign category may represent different types of traffic signs. As discussed in FIG. 1, traffic sign categories may be broad and include category types of signs such as a stop sign, a yield sign, a crossing sign, one-way traffic signs, route, or interstate highways number signs, turn signs, etc. Filtering by traffic sign category may therefore, as discussed in FIG. 6, include time and spatial filtering to select free-flow traffic data where the average vehicle speed may be measured during low traffic volume periods and/or also be filtering out high congestion regions. In addition, a traffic sign filter may eliminate certain data by category type such as deleting low values of speed limits, keeping values associated with a stop sign, and also keeping values associated with a yield sign.

At step 1030 the method may continue by determining from the filtered captured traffic sign data, based on the determining of an average vehicle speed during a non-maximal traffic period, a most likely traffic sign legend. As discussed in FIG. 2 step 280, traffic sign legend determination, a most likely traffic sign value or legend may be determined from the HSVT de-duplicated data. And, in FIG. 6 step 690, based on the determinations of step 660, step 670, and step 680, a final traffic sign value or legend may be identified as the most likely traffic sign legend.

Method 1000 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A system for identifying, flagging, and rectifying unexpected traffic sign data comprising:
a plurality of vehicles, each with a front sensor, configured to capture traffic sign data;
a traffic sign data aggregation system configured to collect and store the captured traffic sign data from the plurality of vehicles over a span of time;
the traffic sign data aggregation system further configured to identify and flag one or more potential false traffic sign detections, from the captured traffic sign data, based on a road category and an associated rule;
a time and spatial filtering system configured to determine, for one or more traffic zones, an average vehicle speed during a non-maximal traffic period;
the time and spatial filtering system further configured to filter the captured traffic sign data based on a traffic sign category;
the traffic sign data aggregation system further configured to determine from the filtered captured traffic sign data, based on the time and spatial filtering system determinations, a most likely traffic sign legend.

2. The system of claim 1, wherein the traffic sign data aggregation system is further configured to perform a data curation to filter un-fit data including data from a selected vehicle identified as a source of error in determining a traffic sign speed limit value.

3. The system of claim 1, wherein the traffic sign category includes a speed limit sign, a stop sign, or a yield sign.

4. The system of claim 1, wherein the road category includes a primary, a secondary, and a tertiary.

5. The system of claim 1, wherein the traffic sign data aggregation system is further configured to flag one or more false traffic sign detections as a high risk when the road category is not a primary level and the speed limit is greater than a threshold value.

6. The system of claim 1, comprising the traffic sign data aggregation system further configured to perform data clustering by grouping traffic sign data associated with a single particular traffic sign.

7. The system of claim 1, wherein the captured traffic sign data from the plurality of vehicles over a span of time comprises data collected and analyzed by a crowdsourcing algorithm.

8. The system of claim 1, comprising where the time and spatial filtering system is further configured to apply a distribution method to process crowdsourced telemetry data including an estimated confidence score.

9. The system of claim 8, wherein the distribution method further comprises estimating a confidence score based on determining a maximum peak value and a qualified peak value from the crowdsourced telemetry data.

10. The system of claim 1, comprising where the time and spatial filtering system is further configured to perform a de-duplication process based on the determined most likely traffic sign legend.

11. The system of claim 1, comprising where the time and spatial filtering system is further configured to filter data based on a speed limit category by filtering out speed values less than a threshold value.

12. A method for identifying, flagging, and rectifying unexpected traffic sign data comprising:
capturing traffic sign data utilizing a plurality of vehicles, wherein each vehicle includes a front sensor configured to capture the traffic sign data;
collecting and storing the captured traffic sign data from the plurality of vehicles over a span of time;
identifying and flagging one or more potential false traffic sign detections, from the captured traffic sign data, based on a road category and an associated rule;
determining, for one or more traffic zones, an average vehicle speed during a non-maximal traffic period;
filtering the captured traffic sign data based on a traffic sign category; and
determining from the filtered captured traffic sign data, based on the determining of an average vehicle speed during a non-maximal traffic period, a most likely traffic sign legend.

13. The method of claim 12, further comprising performing a data curation to filter un-fit traffic sign data including data from a selected vehicle identified as a source of error in determining a traffic sign speed limit value.

14. The method of claim 12, wherein the traffic sign category includes a speed limit sign, a stop sign, or a yield sign.

15. The method of claim 12, further comprising flagging one or more false traffic sign detections as a high risk when the road category is not a primary level and the speed limit is greater than a threshold value.

16. The method of claim 12, further comprising performing data clustering by grouping traffic sign data associated with a single particular traffic sign.

17. The method of claim 12, wherein the captured traffic sign data from the plurality of vehicles over a span of time comprises data collected and analyzed by a crowdsourcing algorithm.

18. The method of claim 12, further comprising applying a distribution method to process crowdsourced telemetry data including estimating a confidence score based on determining a maximum peak value and a set of qualified peak values.

19. The method of claim 12, further comprising performing a de-duplication process based on the determined most likely traffic sign legend.

20. A method for identifying, flagging, and rectifying unexpected traffic sign data comprising:
capturing traffic sign data utilizing a plurality of vehicles, wherein each vehicle includes a front sensor configured to capture the traffic sign data;
collecting the captured traffic sign data from the plurality of vehicles over a span of time;
identifying and flagging one or more potential false traffic sign detections, from the captured traffic sign data, based on a road category and an associated rule;
determining, for one or more traffic zones, an average vehicle speed during a non-maximal traffic period;
filtering the captured traffic sign data based on a traffic sign category, wherein the traffic sign category includes a speed limit sign, a stop sign, or a yield sign;
determining from the filtered captured traffic sign data, based on the determining of an average vehicle speed during a non-maximal traffic period, a most likely traffic sign legend;
performing a data curation to filter un-fit traffic sign data including data from a selected vehicle identified as a source of error in determining a traffic sign speed limit legend;
flagging one or more false traffic sign detections as a high risk when the road category is not a primary level and the speed limit is greater than a threshold value;
performing data clustering by grouping traffic sign data associated with a single particular traffic sign;
applying a distribution method to process crowdsourced telemetry data including estimating a confidence score based on determining a maximum peak value and a set of qualified peak values; and
performing a de-duplication process based on the determined most likely traffic sign legend;
wherein the road category includes a primary, a secondary, and a tertiary; and
wherein the captured traffic sign data from the plurality of vehicles over a span of time comprises data collected and analyzed by a crowdsourcing algorithm.
